(19) United States
(12) Patent Application Publication
(10) Pub. No.: US 2020/0285301 A1
(43) Pub. Date: Sep. 10, 2020

(54) SERVER SYSTEM, SERVER DEVICE AND POWER MANAGEMENT METHOD FOR SERVER DEVICE

(71) Applicant: Wiwynn Corporation, New Taipei City (TW)

(72) Inventor: Cheng-Min Ao, New Taipei City (TW)

(73) Assignee: Wiwynn Corporation, New Taipei City (TW)

(21) Appl. No.: 16/402,236

(22) Filed: May 3, 2019

(30) Foreign Application Priority Data
Mar. 7, 2019 (TW) 108107667

(51) Int. Cl. G06F 1/3296; G06F 1/28

(52) U.S. Cl. CPC G06F 1/3296; G06F 1/28

(57) ABSTRACT

A server system, a server device and a power management method for the server device are provided. The server system includes a first server device, at least one second server device and a power supply. The first server device obtains current power consumption information respectively transmitted by the second server device to calculate a current total power consumption value of the server system. The first server device determines whether it is necessary to raise a first preset power consumption upper limit to a second preset power consumption upper limit according to the current total power consumption value and an operation of the first server device, and determines whether the power supply has excess power according to the current total power consumption value and a total power consumption value of the power supply.

### CROSS-REFERENCE TO RELATED APPLICATION

This application claims the priority benefit of Taiwan application serial no. 108107667, filed on Mar. 7, 2019. The entirety of the above-mentioned patent application is hereby incorporated by reference herein and made a part of this specification.

### BACKGROUND OF THE INVENTION

### 1. Field of the Invention

The invention relates to a power management technique of an electronic apparatus, and particularly relates to a server system, a server device, and a power management method for the server device.

### 2. Description of Related Art

In the technology of data center architecture, it is common to design a large rack to accommodate a plurality of servers, and the servers share the same power supply in the rack. Owing to the power management mechanism of the server, the server usually has a built-in power consumption upper limit set in advance to limit the maximum power consumption of the server. When the server needs power exceeding the watts set in the power consumption upper limit, the power management mechanism (e.g., a power capping mechanism) of the server may automatically underclock the relevant hardware components to prevent the consumed power from exceeding the preset watts, thereby preventing the server from excessively consuming power which may result in overload of the power supply or relevant components (e.g., a power supply system).

While such a power management mechanism protects the power supply, the power management mechanism also limits the operating performance of the server. In other words, the server is not allowed to request more power to satisfy the needs for operating at a high power. Moreover, when some servers do not require the power as high as the power consumption upper limit, the excess power cannot be shared with other servers in the rack. Therefore, the power of the power supply or the power supply system is not used efficiently.

### SUMMARY OF THE INVENTION

The embodiments of the invention provide a server system, a server device, and a power management method for the server device. The server device may transmit the information that the server device has excess power resources to other server devices, and a server device requiring more power may raise a preset power consumption upper limit of the server device by exploiting the excess power resources, thereby using a power supply or a power supply system more effectively.

A server system according to an embodiment of the invention includes a first server device, at least one second server device, and a power supply. The first server device has a first preset power consumption upper limit. The at least one second server device communicates with the first server device. The power supply supplies power of a total power consumption value to the first server device and the second server device. The first server device obtains current power consumption information respectively transmitted by the second server device to calculate a current total power consumption value of the server system. The first server device determines whether it is necessary to raise the first preset power consumption upper limit to a second preset power consumption upper limit according to the current total power consumption value and an operation of the first server device, and determines whether the power supply has excess power according to the current total power consumption value and the total power consumption value of the power supply. The first server device raises the first preset power consumption upper limit to the second preset power consumption upper limit in response to a determination that it is necessary to raise the preset power consumption upper limit and a determination that the power supply has the excess power.

A server device according to an embodiment of the invention includes a sensor, a transmitter, a receiver, and a controller. The sensor is configured to sense power consumption of the server device to generate current power consumption information of the server device. The transmitter is coupled to the sensor. The transmitter transmits the current power consumption information to at least one other server device. The receiver obtains the current power consumption information respectively transmitted from the at least one other server device. The controller is coupled to the receiver. The controller obtains the current power consumption information of the at least one other server device through the receiver, and calculates a current total power consumption value of a server system in which the server device is arranged. The controller determines whether it is necessary to raise a first preset power consumption upper limit in the server device to a second preset power consumption upper limit according to the current total power consumption value and an operation of the server device, and determines whether a power supply in the server system has excess power according to the current total power consumption value and a total power consumption value of the power supply. The controller raises the first preset power consumption upper limit to the second preset power consumption upper limit in response to a determination that it is necessary to raise the first preset power consumption upper limit and a determination that the power supply has the excess power.

A power management method for a server device according to an embodiment of the invention includes the following: obtaining current power consumption information of at least one other server device and the server device; calculating a current total power consumption value of a server system in which the server device is arranged according to the current power consumption information of the at least one other server device and the server device; determining whether it is necessary to raise a first preset power consumption upper limit in the server device to a second preset power consumption upper limit according to the current total power consumption value and an operation of the server device, and determining whether a power supply in the server system has excess power according to a total power consumption value of the power supply and the current total power consumption value; and raising the first preset power consumption upper limit to the second preset power consumption upper limit in response to a determination that it is necessary to raise the first preset power consumption upper limit and a determination that the power supply has the excess power.

Based on the above, the server system, the server device, and the power management method for the server device according to the embodiments of the invention allow the server devices to communicate with each other to notify at least one other server device that there is excessive power available, and each server device may determine on its own whether it is necessary to raise the power consumption upper limit of the server device according to the information about the power resources. In this way, a server device requiring more power is able to exploit the excess power resources and raise the preset power consumption upper limit of the server device, and at least one other server device may also correspondingly lower their preset power consumption upper limit to meet the total power consumption of the power supply system in the server system, so as to more effectively use the power supply or the power supply system.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a server system according to an embodiment of the invention.

FIG. 2 is a functional block diagram of a server device of FIG. 1.

FIG. 3 is a flowchart illustrating a power management method for a server device according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

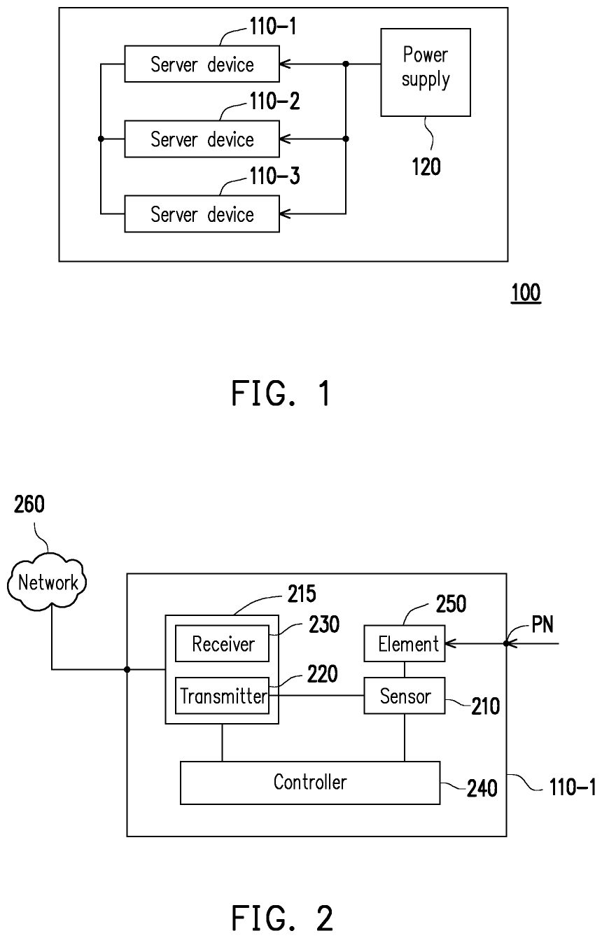

FIG. 1 is a schematic view illustrating a server system 100 according to an embodiment of the invention. The server system 100 may be a rack server, and may include a plurality of server devices 110-1 to 110-3 and a power supply 120. For the ease of description, an example is described herein with three server devices 110-1 to 110-3. However, those utilizing the embodiment may adjust the number of the server devices in the server system 100 according to their needs, and the server system 100 of the embodiment requires at least two servers to be realized. The server devices 110-1 to 110-3 may be blade servers, for example. In addition, in the embodiment, the server device 110-1 is referred to as a first server device, and the server devices 110-2 to 110-3 are referred to as second server devices.

The power supply 120 may be a rack power supply or a power supply system and is configured to supply power to the entire server system 100. In other words, the power supply 120 supplies power of the total power consumption value of the entire server system 100 to the first server device 110-1 and the second server devices 110-2 to 110-3. The power supply 120 is externally connected to the grid or an external facility power source, and coverts the power into a voltage suitable for the servers 110-1 to 110-3.

For example, if the total power consumption value that the power supply 120 is able to supply is 2400 watts, the preset power consumption upper limit of each of the server devices 110-1 to 110-3 may be set at 800 watts. In this way, when each of the server devices 110-1 to 110-3 is operated at 800 watts, the power supply 120 may maintain normal operation. Meanwhile, if the server devices 110-2 to 110-3 both have excess power resources for exploitation of other server devices, a server device (e.g., the server device 110-1) requiring more power according to the embodiment of the invention may make use of the excess power resources and raise its preset power consumption upper limit, such as raising the preset power consumption upper limit from 800 watts to 900 watts, so that the server system 100 perform to a full extent. The other two server devices 110-2 to 110-3 also lower their preset power consumption upper limits from 800 watts to 750 watts, so as to relocate the excess power resources for exploitation of the server device 110-1. In other words, in the embodiment, each of the server devices 110-1 to 110-3 is able to adjust its preset power consumption upper limit according to its own operating requirements, and other server devices also correspondingly lower their preset power consumption upper limits, so that the server system 100 can be used more effectively under the condition of meeting the total power consumption of the power supply 120.

The server devices 110-1 to 110-3 of the embodiment have the same structure. Here, the server device 110-1 is described as an example. FIG. 2 is a functional block diagram of the server device 110-1 of FIG. 1. The server device 110-1 mainly includes a sensor 210, a transmitter 220, a receiver 230, and a controller 240. The receiver 230 and the transmitter 220 may also be referred to as a network transmission apparatus 215. The controller 240 may be a board management controller. The server device 110 may further include an element 250 that is operating and consuming power. The element 250 may be various components in the server device 110-1, such as a central processing unit, the network transmission apparatus 215 (e.g., the transmitter 220 and the receiver 230), the board management controller (i.e., the controller 240), etc. The sensor 210 is configured to sense the total power consumption of the server device 110-1 to generate the current power consumption information of the server device 110-1. The sensor 210 of the embodiment may be respectively disposed at the location where power is supplied to each element 250 in the server device 110-1, so as to detect the power consumption of each element 250 as the power consumption information, and the transmitter 220 or the controller 240 may sum up the power consumption information to serve as the current power consumption information of the server device 110-1. In some embodiments, the sensor 210 may also be disposed at a power input end PN of the server device 110-1 that is connected to the power supply 120, so as to detect and generate the current power consumption information of the entire server device 110-1.

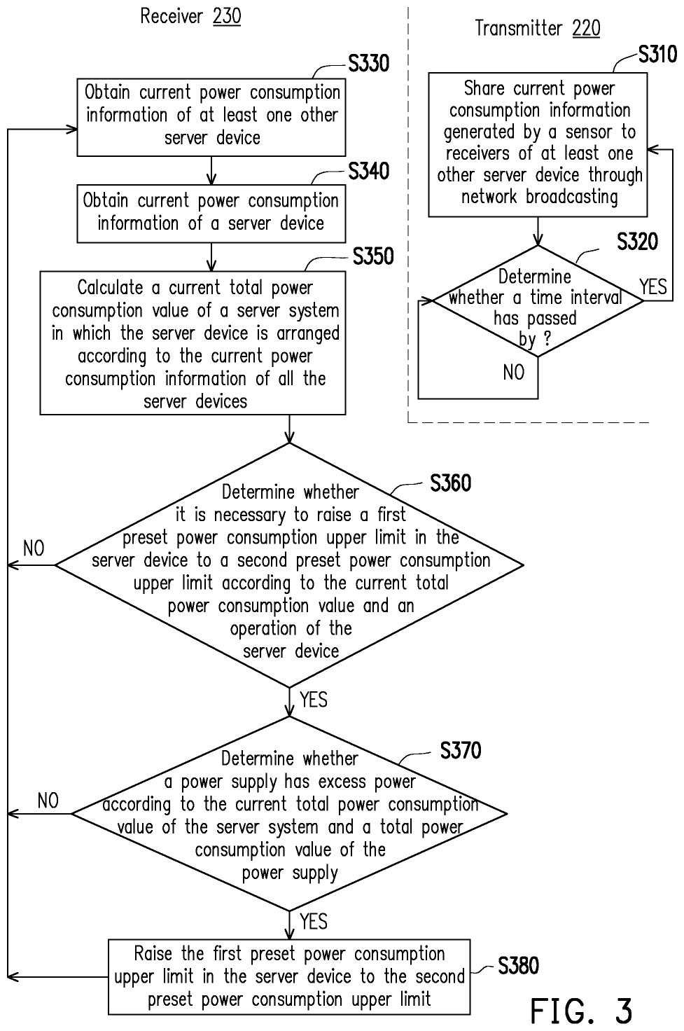

Here, the respective elements (e.g., the sensor 210, the transmitter 220, the receiver 230, and the controller 240) of the server device 110-1 shown in FIG. 2 are used to describe the respective steps of a power management method for a server device disclosed in FIG. 3. FIG. 3 is a flowchart illustrating a power management method for the server device 110-1 according to an embodiment of the invention. Those utilizing the embodiment may apply the power management method shown in FIG. 3 to any of the server devices 110-1 to 110-3 in the server system 100 shown in FIG. 1, and the power management method is not limited to the server device 110-1.

Referring to FIGS. 1 and 3, the transmitter 220 is coupled to the sensor 210 to transmit the current power consumption of the entire server device 110-1 to at least one other server device (i.e., other server devices 110-2 to 110-3) other than the server device 110-1. Specifically, the network transmission apparatus 215 of FIG. 2 is connected to a network 260 formed by the server devices 110-1 to 110-3 of FIG. 1. At Step S310, the controller 240 controls the transmitter 220 to share the current power consumption information of the server device 110-1 generated by the sensor 210 to the receivers of the at least one other server device (e.g., the server devices 110-2 to 110-3 shown in FIG. 1) through network broadcasting via the network 260. At Step S320, the controller 240 determines whether a time interval (e.g., 3 seconds, 4 seconds, 5 seconds, etc., based on needs) has passed by, and performs Step S310 again when the time interval has passed by, so as to continuously share the current power consumption information of the server device 110-1 to other server devices 110-2 to 110-3. According to relevant embodiments of the invention, depending on the design requirements of those utilizing the embodiments, it may also be that the transmitter 220 shares the current power consumption information of the server device 110-1 to other server devices without going through the controller 240 (Step S310), and the transmitter 220 may determine on its own whether the time interval has passed by (Step S320) to perform Step S310 again, so as to alleviate the computational load of the controller 240.

The controller 240 is coupled to the receiver 230. At Step S330, the receiver 230 obtains the current power consumption information respectively transmitted from other server devices 110-2 to 110-3 to the server device 110-1, and provides the current power consumption information of the server devices 110-2 to 110-3 to the controller 240. The controller 240 obtains the current power consumption information of other server devices 110-2 to 110-3. At Step S340, the controller 240 obtains the current power consumption information of the server device 110-1 from the sensor 210. Accordingly, through Steps S330 to S340, the controller 240 can obtain the respective current power consumption information of all the server devices 110-1 to 110-3 in the server system 100.

At Step S350, the controller 240 calculates a current total power consumption value PSUtp of the server system 100 in which the server device 110-1 is arranged according to the current power consumption information of all the server devices 110-1 to 110-3. For example, assuming that the server system 100 has n server devices, n being a positive integer greater than or equal to 2, and the current power consumption of each server device indicates that the current power consumption of each server device is Pn, the controller 240 may sum up the current power consumption of each server device to calculate the current total power consumption value PSUtp of the server system 100. In other words, the current total power consumption value PSUtp of the server system 100 is P1+P2+ . . . Pn. Besides, the controller 240 may further calculate a current power utilization rate of the power supply 120 in FIG. 1 according to the current total power consumption value PSUtp as the reference for determining whether the power supply 120 has excess power resources. For example, the value derived by dividing the current total power consumption value PSUtp by the total power consumption value (2400 watts) of the power supply 120 is the current power utilization rate of the power supply 120.

At Step S360, the controller 240 determines whether it is necessary to raise a first preset power consumption upper limit (e.g., 800 watts) of the server device 110-1 to a second preset power consumption upper limit (e.g., 900 watts) according to the current total power consumption value PSUtp and the operation of the server device 110-1. Specifically, if the current power consumption of the server device 110-1 has reached or exceeded the first preset power consumption upper limit, the server 110-1 is throttling and the controller 240 needs more power resources. Therefore, if the current power consumption of the server device 110-1 has reached or exceeded the first preset power consumption upper limit, the determination at Step S360 is “YES”, and the flow proceeds to Step S370. Comparatively, if the current power consumption of the server device 110-1 is less than the first preset power consumption upper limit, the determination at Step S360 is “NO”, and the flow returns to Step S330.

At Step S370, the controller 240 determines whether the power supply 120 has excess power according to the current total power consumption value PSUtp of the server system 100 and the total power consumption value (e.g., 2400 watts) of the power supply 120. The controller 240 may resort to various ways to determine whether the power supply 120 has excess power, such as making a determination according to the current power utilization rate of the power supply 120, or making a determination on whether the server system 100 still has excess power resources according to the remainder obtained by subtracting the current total power consumption value PSUtp of the server system 100 from the total power consumption value of the power supply 120.

When it is determined that it is necessary to raise the first preset power consumption upper limit of the server device 110-1 and it is determined that the power supply 120 has excess power resources, at Step S380, the controller 240 may raise the first preset power consumption upper limit (e.g., 800 watts) to the second preset power consumption upper limit (e.g., 900 watts).

In the embodiment, in order to prevent the server devices 110-1 to 110-3 from raising the power consumption upper limits on their own and exceeding of the power resource supply upper limit of the power supply 120, one or more of the second server devices 110-2 to 110-3 may lower its/their preset power consumption upper limits according to its/their operation modes before the server device 110-1 raises the first preset power consumption upper limit of the server device 110-1 to the second preset power consumption upper limit. For example, the controllers in the second server devices 110-2 to 110-3 may determine whether the second server devices 110-2 to 110-3 need this much of the power resources according to the operations and the power consumption information of the second server devices 110-2 to 110-3, and may lower their power consumption upper limits (e.g., from 800 watts to 750 watts) if the second server devices 110-2 to 110-3 do not need this much of the power resources. In this way, each of the second server devices 110-2 to 110-3 releases power resources of 50 watts as the excess power of the power supply 120. Meanwhile, the total of the preset power consumption upper limits of the first server device 110-1 and the second server devices 110-2 to 110-3 of the embodiment does not exceed the total power consumption value of the power supply 120.

In view of the foregoing, the server system, the server device, and the power management method for the server device according to the embodiments of the invention allow the server devices to communicate with each other to notify other server devices that there is excessive power available, and each server device may determine on its own whether it is necessary to raise the power consumption upper limit of the server device according to the information about the power resources. In this way, a server device requiring more power is able to exploit the excess power resources and raise the preset power consumption upper limit of the server device, and other server devices may also correspondingly lower their preset power consumption upper limit to meet the total power consumption of the power supply system in the server system, so as to more effectively use the power supply or the power supply system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A server system, comprising:
a first server device, having a first preset power consumption upper limit;
at least one second server device, communicating with the first server device; and
a power supply, supplying power of a total power consumption value to the first server device and the second server device,
wherein the first server device obtains current power consumption information respectively transmitted by the at least one second server device, so as to calculate a current total power consumption value of the server system,
the first server device determines whether it is necessary to raise the first preset power consumption upper limit to a second preset power consumption upper limit according to the current total power consumption value and an operation of the first server device, and determines whether the power supply has excess power according to the current total power consumption value and the total power consumption value of the power supply, and
the first server device raises the first preset power consumption upper limit to the second preset power consumption upper limit in response to a determination that it is necessary to raise the first preset power consumption upper limit and a determination that the power supply has the excess power.

2. The server system as claimed in claim 1, wherein before the first server device raises the first preset power consumption upper limit to the second preset power consumption upper limit, one of the at least one second server device lowers a preset power consumption upper limit of the one of the at least one second server device.

3. The server system as claimed in claim 1, wherein a total of the first preset power consumption upper limit of the first server device and the second preset power consumption upper limit of the at least one second server device does not exceed the total power consumption value of the power supply.

4. The server system as claimed in claim 1, wherein each of the first server device and the at least one second server device is one of a plurality of server devices, and the server device comprises:
a sensor, configured to sense power consumption of the server device to generate the current power consumption information;
a transmitter, coupled to the sensor and transmitting the current power consumption information to at least one other server device other than the server device;
a receiver, obtaining the current power consumption information respectively transmitted from the at least one other server device to the server device; and
a board management controller, coupled to the receiver, and obtaining the current power consumption information of the at least one other server device through the receiver.

5. The server system as claimed in claim 4, wherein the transmitter shares the current power consumption information generated by the sensor to the receivers of the at least one other server device through network broadcasting.

6. A server device, comprising:
a sensor, configured to sense power consumption of the server device to generate current power consumption information of the server device;
a transmitter, coupled to the sensor and transmitting the current power consumption information to at least one other server device;
a receiver, obtaining the current power consumption information respectively transmitted from the at least one other server device; and
a controller, coupled to the receiver, obtaining the current power consumption information of the at least one other server device through the receiver, and calculating a current total power consumption value of a server system in which the server device is arranged,
the controller determines whether it is necessary to raise a first preset power consumption upper limit in the server device to a second preset power consumption upper limit according to the current total power consumption value and an operation of the server device, and determines whether a power supply in the server system has excess power according to the current total power consumption value and a total power consumption value of the power supply, and
the controller raises the first preset power consumption upper limit to the second preset power consumption upper limit in response to a determination that it is necessary to raise the first preset power consumption upper limit and a determination that the power supply has the excess power.

7. The server device as claimed in claim 6, wherein the server device and the at least one other server device are connected to a network of the server system, such that the server device and the at least one other server device communicate with each other, and
the controller is a board management controller.

8. The server device as claimed in claim 6, wherein before the controller raises the first preset power consumption upper limit to the second preset power consumption upper limit, one of the at least one other server device lowers a preset power consumption upper limit of the one of the at least one other server device.

9. The server device as claimed in claim 6, wherein a total of preset power consumption upper limits of the server device and the at least one other server device does not exceed the total power consumption value of the power supply.

10. A power management method for a server device, comprising:
obtaining current power consumption information of at least one other server device and the server device;
calculating a current total power consumption value of a server system in which the server device is arranged according to the current power consumption information of the at least one other server device and the server device;
determining whether it is necessary to raise a first preset power consumption upper limit in the server device to a second preset power consumption upper limit according to the current total power consumption value and an operation of the server device, and determining whether a power supply in the server system has excess power according to a total power consumption value of the power supply and the current total power consumption value; and
raising the first preset power consumption upper limit to the second preset power consumption upper limit in response to a determination that it is necessary to raise the first preset power consumption upper limit and a determination that the power supply has the excess power.
